(19) United States
(12) Patent Application Publication
(10) Pub. No.: US 2017/0301963 A1
(43) Pub. Date: Oct. 19, 2017

(54) METHOD AND APPARATUS FOR PERFORMING STRING-LEVEL DYNAMIC RECONFIGURATION IN AN ENERGY SYSTEM

(71) Applicant: Pathion Inc., Los Gatos, CA (US)

(72) Inventors: David R. Smith, Los Gatos, CA (US); David C. Reuter, Los Gatos, CA (US); Daniel West, Los Gatos, CA (US)

(73) Assignee: Pathion Inc., Los Gatos, CA (US)

(21) Appl. No.: 15/439,203

(22) Filed: Feb. 22, 2017

Related U.S. Application Data
(63) Continuation of application No. PCT/US2015/046492, filed on Aug. 24, 2015.
(60) Provisional application No. 62/040,723, filed on Aug. 22, 2014.

(51) Int. Cl. H01M 10/48; H01M 16/00; H01M 10/44; H02J 7/00

(52) U.S. Cl. CPC H01M 10/48; H02J 7/0024; H02J 7/0021; H01M 10/44; H01M 16/00; H01M 2200/103

(57) ABSTRACT

Described is a reconfigurable energy storage system that is capable of switching an arrangement of energy storage cells from a series configuration to a parallel configuration, from a parallel configuration to a series configuration, or both.

### BACKGROUND OF THE INVENTION

There is a demand for large-format energy storage systems as markets for electric vehicles and stationary energy storage grow. Large-format battery energy storage systems are useful for storing energy produced from any source. Energy storage systems are desired for applications such as renewable energy integration, ancillary services, microgrid support, demand charge reduction, and backup power. Such systems can involve an array of batteries in electrical connection, where the batteries are arranged in a plurality of energy storage segments that make up the energy storage system. A battery management system is an electronic system that manages battery cells in such an energy storage system.

Stringent manufacturing processes and battery cell material characteristics place practical limitations on the amount of energy or power that can be stored in a single battery cell, while the specific electrochemical characteristics of a given battery chemistry limit the voltage of a single cell, typically to less than five volts. For these and other reasons, most large-format energy storage systems include hundreds or thousands of individual battery cells that are combined in static series and parallel configurations in order to meet the energy and voltage requirements of a particular application.

One approach to configuring an optimal system design can involve dividing the total energy storage need by the individual cell capacity to determine the number of cells X required, dividing the total desired voltage by the individual battery cell voltage to determine the number of cells Y in each string, and combining Z of these strings in parallel, where the product of Y times Z is reasonably close to X. In practice, however, the capacity of a battery cell declines with age and use, and the voltage fluctuates with the state of charge of the battery cell and state of balance with the rest of the system. Both of these parameters can differ increasingly from battery cell to battery cell as the system ages.

The effects of these cell-to-cell differences vary with the battery cell chemistry and form factor, the system size and complexity, the end use application, environmental conditions, and any number of other factors. One common limitation introduced by this non-uniformity is a decrease in the accessible state of charge window to that of the weakest cell within the system, meaning that the energy storage system can no longer be safely charged and discharged to the same levels. At best, this means a loss in the amount of energy that can actually be stored and extracted from the system. At worst, this can lead to potentially dangerous overcharging or over-discharging events that force battery cells into thermal runaway and pose a safety hazard.

Static energy storage system configurations pose a range of other challenges as well, including: (1) a typical inflexibility to changes that may be necessitated by changes in end use applications; (2) reliability issues caused by the need to bring a significant portion of the system offline even if only a single battery cell is underperforming; (3) expensive emergency maintenance that stems from the above-mentioned reliability issues; and (4) large voltage fluctuations across a state of charge of the system that can result in untenable or suboptimal output voltages. Therefore, there is a need in the art for improved energy storage systems.

### SUMMARY OF THE INVENTION

Described is a dynamically reconfigurable framework for a large-scale battery or other energy storage system, referred to as a reconfigurable energy storage system. A reconfigurable energy storage system includes a negative electrical bus, a positive electrical bus, a plurality of energy storage strings connected between the negative electrical bus and the positive electrical bus, and a control unit in electrical communication with the negative electrical bus, the positive electrical bus, and the plurality of energy storage strings. The energy storage strings include at least a first energy storage string and a second energy storage string, where each string has a negative input terminal and a positive output terminal. Furthermore, each energy storage string has at least a first subset of energy storage cells and a second subset of energy storage cells, where each subset includes at least two blocks of energy storage cells arranged in an internal series or parallel configuration such that the arrangement includes an intra-string positive terminal and an intra-string negative terminal interposed between the negative input terminal and the positive output terminal. Each energy storage string further includes an input switch connected between the negative electrical bus and the negative terminal of the energy storage string, a first output switch connected between the positive electrical bus and the intra-string positive terminal, a second output switch connected between the positive electrical bus and the positive terminal of the energy storage string, and a series switch connected between the intra-string positive terminal and the intra-string negative terminal. The energy storage system further includes a multi-string series switch connected between the positive output terminal of the first energy storage string and the intra-string negative terminal of the second energy storage string, as well as an initial input switch connected between the negative electrical bus and the intra-string negative terminal of the first energy storage string. The control unit is configured to reconfigure (i) at least one parallel arrangement of energy storage cells in the system to a series arrangement of energy storage cells, or (ii) at least one series arrangement of energy storage cells in the system to a parallel arrangement of energy storage cells.

In some embodiments, the control unit is configured to receive an output criteria and control the multi-string series switch and each input switch, output switch, second output switch, and series switch in the system to output power through the negative electrical bus and the positive electrical bus. The output criteria can be any combination of energy, power, or voltage requirements.

Various aspects of this invention will become apparent to those skilled in the art from the following detailed description of the preferred embodiment, when read in light of the accompanying drawings.

### BRIEF DESCRIPTION OF THE DRAWINGS

The patent or patent application file contains one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Non-limiting illustration of an energy storage system tied to the power grid, a solar panel, and a wind turbine, configured to deliver the stored energy to a home.

FIG. 2: Non-limiting illustration of battery banks in an energy storage system.

FIG. 3: Diagram that depicts an exemplary arrangement for a reconfigurable energy storage system. The blue lines indicate part of the 3×8 parallel configuration circuit, and the purple lines indicate part of the 4×6 series configuration circuit.

FIG. 4: Diagram that depicts an exemplary arrangement for a reconfigurable energy storage system when operating in a “normal” configuration. The blue lines indicate part of the 3×8 parallel configuration circuit, and the purple lines indicate part of the 4×6 series configuration circuit.

FIG. 5: Diagram that depicts an exemplary arrangement for a reconfigurable energy storage system when operating in a ‘boosted’ configuration. The blue lines indicate part of the 3×8 parallel configuration circuit, and the purple lines indicate part of the 4×6 series configuration circuit.

FIG. 6: Graph that depicts voltage as a function of state of charge for a typical discharge of an exemplary reconfigurable energy storage system featuring a dynamic reconfiguration event as the system nears a 30 percent state of charge. The would-be voltage of the “unboosted” system is shown in red for comparison to the “boosted” voltage following reconfiguration of the system.

FIG. 7: Diagram that depicts an exemplary multi-chemistry direct-current reconfigurable energy storage system.

FIG. 8: Chart that depicts the top-of-charge and end-of-charge voltages of an exemplary multi-chemistry direct-current energy storage system.

### DETAILED DESCRIPTION

This disclosure relates in general to energy storage system management. In particular, this disclosure relates to a dynamically reconfigurable energy storage system usable for, by way of a non-limiting example, a large-scale battery storage system. The reconfigurable energy storage system is capable of dynamic string-level reconfiguration.

Generally speaking, rechargeable battery cells are energy storage elements that are capable of converting electrical energy to chemical energy when serving as a load, storing this chemical energy for a period of time, and converting the stored chemical energy to electrical energy when a load is applied to the cell. Exemplary battery cells include, but are not limited to, lithium ion, lithium iron phosphate, lithium sulfur, lithium titanate, nano lithium titanate oxide, nickel metal hydride, nickel cadmium, nickel hydrogen, nickel-iron, sodium sulfur, vanadium redox, rechargeable alkaline, or aqueous hybrid ion. The battery management system framework of this disclosure, which provides for dynamic string-level reconfiguration, can be applied to any of these types of battery cells (or others, if desired), as well as to fuel cells, capacitors, and hybrid battery-capacitor cells. The reconfigurable energy storage system will be described with reference to battery cells for purposes of explanation, but it is understood that the system is useful in connection with any type of energy storage elements or devices.

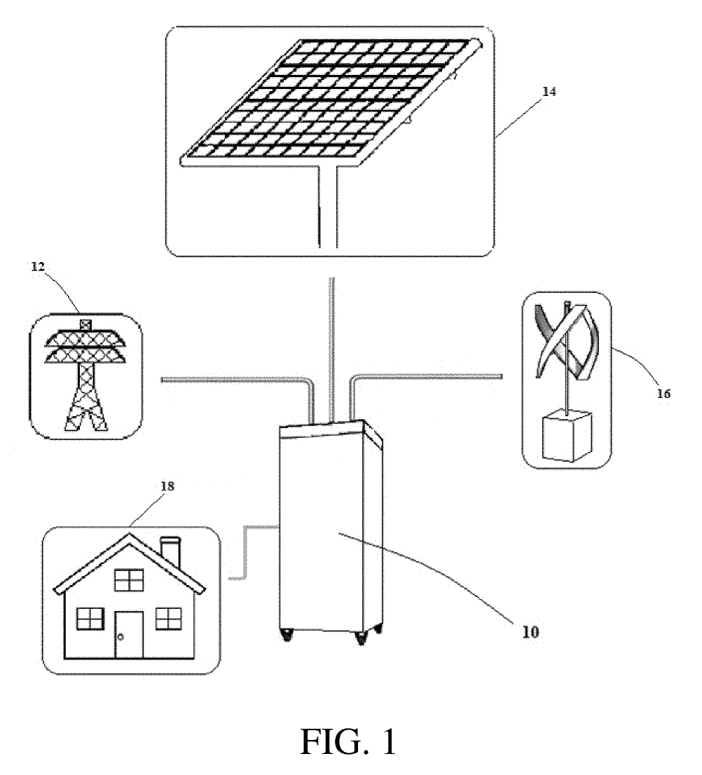

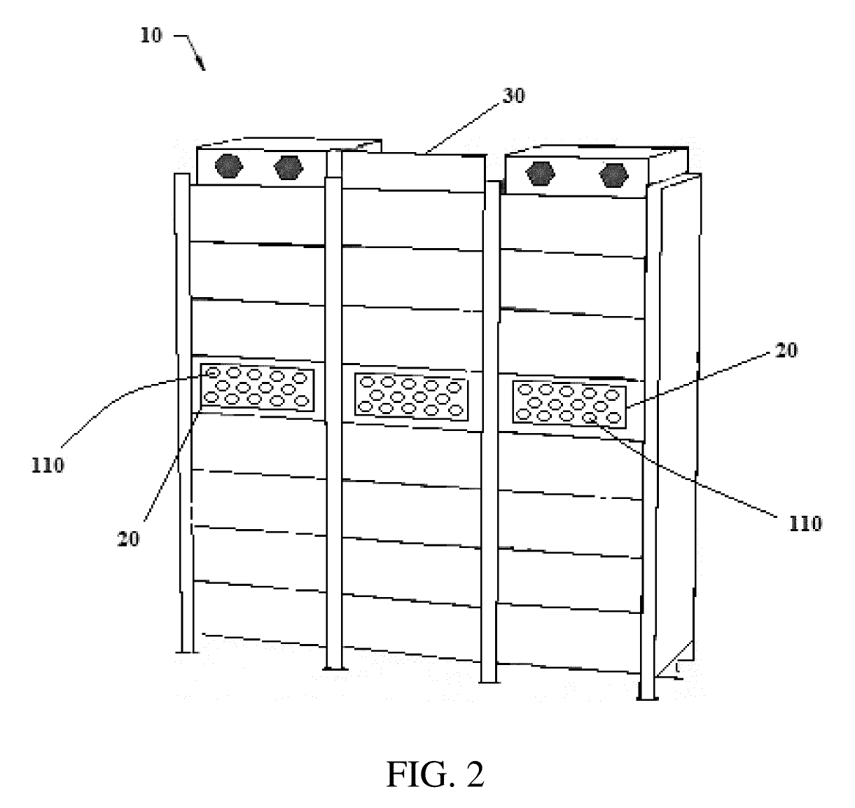

As illustrated in FIG. 1, a large-format battery energy storage system 10 can store energy produced from any source such as a power grid 12, solar panels 14, or wind turbines 16, among other examples, and controllably deliver such energy to houses 18 or the like. Such systems generally involve an array of batteries 110 in electrical connection. The batteries 110 can be arranged in a plurality of energy storage segments, or battery banks 20, that make up the energy storage system. Multiple battery banks 20 can be configured in connected modular units 30, as illustrated in FIG. 2.

As shown in FIG. 2, an energy storage system 10 can include multiple battery banks 20 composed of multiple batteries 110, where the battery banks 20 can be housed in modular units 30. Within a battery bank 20, any suitable configuration of a plurality of battery cells 110 can be interconnected. Provided herein is an energy storage system capable of reconfiguring itself dynamically at the string level, referred to as a reconfigurable energy storage system.

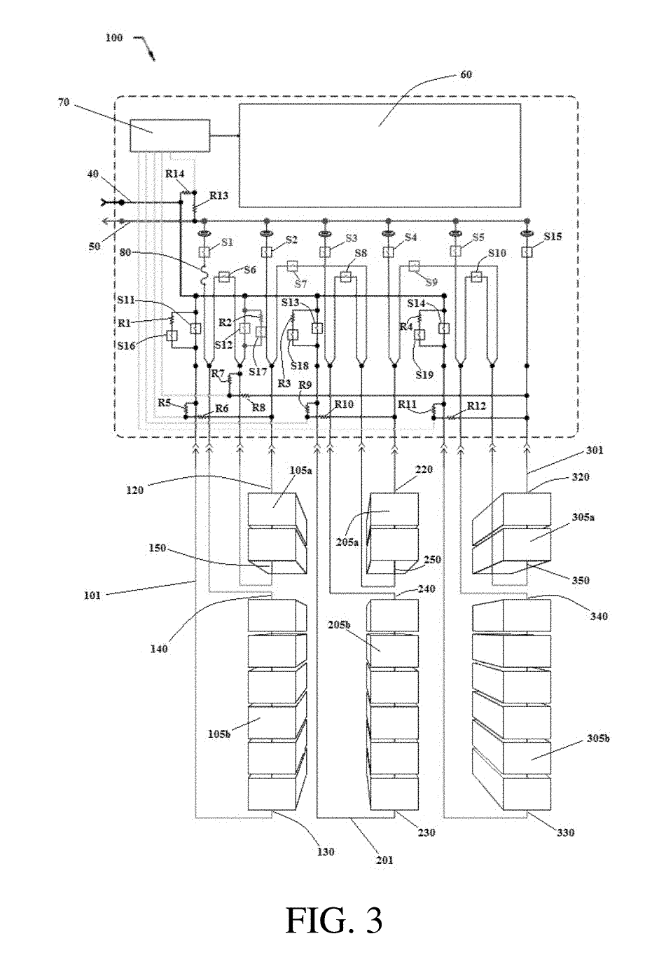

A diagram of an exemplary reconfigurable energy storage system 100 in accordance with the present disclosure is illustrated in FIG. 3. As shown in FIG. 3, a reconfigurable energy storage system 100 includes, for example, twenty-four energy blocks, with each energy block including a number A of energy storage cells (e.g., battery cells) 110 that are connected in series. Different implementations may contain a different number of energy blocks and/or differing numbers of energy storage cells 110 in any number of the constituent energy blocks. The exemplary system in FIG. 3 contains energy storage cells 110 that are of a uniform technology. However, different implementations of the system may include those where any number of blocks may contain a different direct-current energy technology, which includes but is not limited to battery cells of differing chemistry, form factor, capacity, or performance characteristics; capacitors; fuel cell elements; solar photovoltaic elements; and the like.

For ease of reference in FIGS. 3-5, like components of different energy storage strings are referred to with corresponding reference numbers. For instance, a component of the first energy storage string 101 given the reference number 105 would be analogous to a component of the second energy storage string 201 given the number 205, both of which would be analogous to a component of the third energy storage string 301 given the number 305, and so on.

As shown in FIG. 3, each energy storage string includes at least two subsets of energy blocks, where each energy block contains a plurality of energy storage cells (such as battery cells or other energy storage devices). FIG. 3 shows an example where a first energy storage string 101 includes a first subset of energy blocks 105a and a second subset of energy blocks 105b. The second energy storage string 201 includes a first subset of energy blocks 205a and a second subset of energy blocks 205b. The third energy storage string 301 includes a first subset of energy blocks 305a and a second subset of energy blocks 305b. The reconfigurable energy storage system 100 illustrated in FIG. 3 configures the energy blocks in a number B strings, a number C of which contain a number D of energy blocks each in series and a number E of which contain a number F of energy blocks each in series, wherein the numbers B, C, D, E, and F may, for example, be equal to 6, 3, 2, 3, and 6, respectively. This exemplary configuration results in the nominal voltage of the multiplied number of C blocks times D blocks being equal to that of a substring containing F blocks, although this condition need not constrain the design of differing implementations and, therefore, is not required.

Each subset of energy blocks in each energy storage string includes a plurality of energy blocks containing a plurality of energy storage cells that are internally arranged in either a series or parallel configuration. Thus, each energy storage string contains not only a positive output terminal 120, 220, 320 and a negative input terminal 130, 230, 330, but also at least one intra-string positive terminal 140, 240, 340 and at least one intra-string negative terminal 150, 250, 350. When more than two subsets of energy blocks are present in an energy storage string, the energy storage string contains more than one intra-string positive terminal and more than one intra-string negative terminal. For ease of illustration, FIG. 3 depicts a system having three energy storage strings 101, 201, 301, each string having two subsets of energy blocks: a first subset 105a, 205a, 305a containing two blocks of energy storage cells and a second subset 105b, 205b, 305b containing six blocks of energy storage cells. In this non-limiting embodiment, which contains 24 blocks of energy storage cells, the reconfigurable energy storage system 100 is able to switch between a 3×8 parallel configuration and a 4×6 series configuration.

The reconfigurable energy storage system 100 includes multiple types of switches. The functions and locations of these switches are described with reference to FIGS. 3-5, though it is understood that other configurations, including the addition or omission of various switches, are possible. Each energy storage string 101, 201, 301 has an input switch (S11, S13, and S14 in FIGS. 3-5), a first output switch (S1, S3, and S5 in FIGS. 3-5), a second output switch (S2, S4, and S15 in FIGS. 3-5), and a series switch (S6, S8, and S10 in FIGS. 3-5). Thus, the first energy storage string 101 has a first string input switch S11, the second energy storage string 201 has a second string input switch S13, and the third energy storage string 301 has a third string input switch S14. The first energy storage string 101 has a first string first output switch S1, the second energy storage string 201 has a second string first output switch S3, and the third energy storage string 301 has a third string first output switch S5. The first energy storage string 101 has a first string second output switch S2, the second energy storage string 201 has a second string second output switch S4, and the third energy storage string 301 has a third string second output switch S15. The first energy storage string 101 has a first string series switch S6, the second energy storage string 201 has a second string series switch S8, and the third energy storage string has a third string series switch S10.

The input switch of each energy storage string is connected between the negative electrical bus 40 and the negative input terminal of the respective energy storage string. Therefore, the first string input switch S11 is connected between the negative electrical bus 40 and the first string negative input terminal 130. The second string input switch S13 is connected between the negative electrical bus 40 and the second string negative input terminal 230. The third string input switch S14 is connected between the negative electrical bus 40 and the third string negative input terminal 330.

The first output switch of each energy storage string is connected between the positive electrical bus 50 and the intra-string positive terminal of the respective energy storage string. Therefore, the first string first output switch S1 is connected between the positive electrical bus 50 and the first string intra-string positive terminal 140. The second string first output switch S3 is connected between the positive electrical bus 50 and the second string intra-string positive terminal 240. The third string first output switch S5 is connected between the positive electrical bus 50 and the third string intra-string positive terminal 340.

The second output switch of each energy storage string is connected between the positive electrical bus 50 and the positive output terminal of the respective energy storage string. Therefore, the first string second output switch S2 is connected between the positive electrical bus 50 and the first string positive output terminal 120. The second string second output switch S4 is connected between the positive electrical bus 50 and the second string positive output terminal 220. The third string second output switch S15 is connected between the positive electrical bus 50 and the third string positive output terminal 320.

The series switch of each energy storage string is connected between the intra-string negative terminal and the intra-string positive terminal of the same energy storage string. Therefore, the first string series switch S6 is connected between the first string intra-string negative terminal 150 and the first string intra-string positive terminal 140. The second string series switch S8 is connected between the second string intra-string negative terminal 250 and the second string intra-string positive terminal 240. The third string series switch S10 is connected between the third string intra-string negative terminal 350 and the third string intra-string positive terminal 340.

The system also includes one multi-string series switch (S7 and S9 in FIGS. 3-5) for each energy storage string present in excess of the first energy storage string 101. In other words, the number of multi-string series switches present equals n−1, where n is the total number of energy storage strings in the system. Thus, a reconfigurable energy storage system having a total of three energy storage strings includes two multi-string series switches. The multi-string series switches are connected between the positive output terminal of a first battery string and the intra-string negative terminal of a second battery string. Therefore, as shown in FIGS. 3-5, the first multi-string series switch S7 is connected between the first string positive output terminal 120 and the second string intra-string negative terminal 250. The second multi-string series switch S9 is connected between the second string positive output terminal 220 and the third string intra-string negative terminal 350.

The system further includes an initial input switch (shown as S12 in FIGS. 3-5) connected between the negative electrical bus 40 and the first string intra-string negative terminal 150.

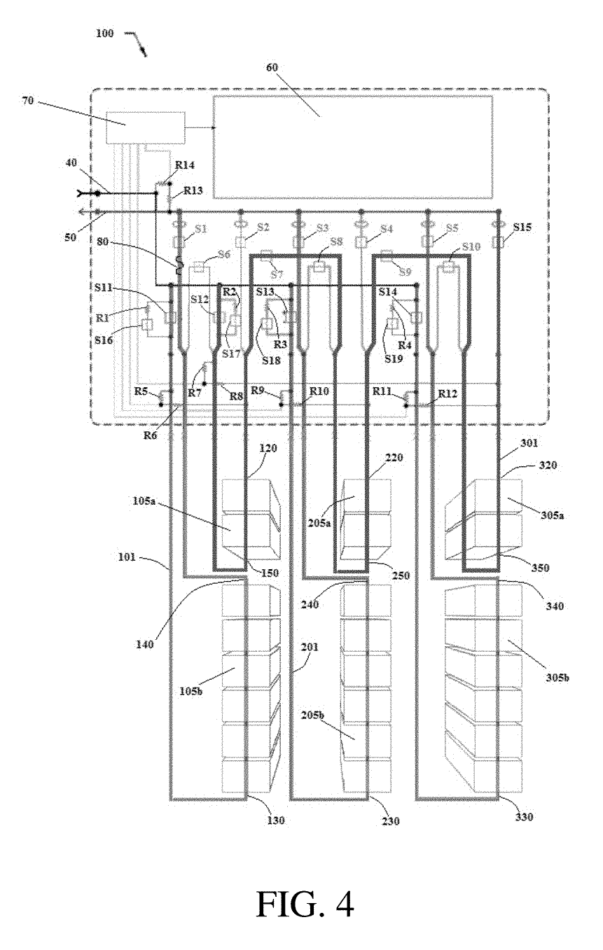

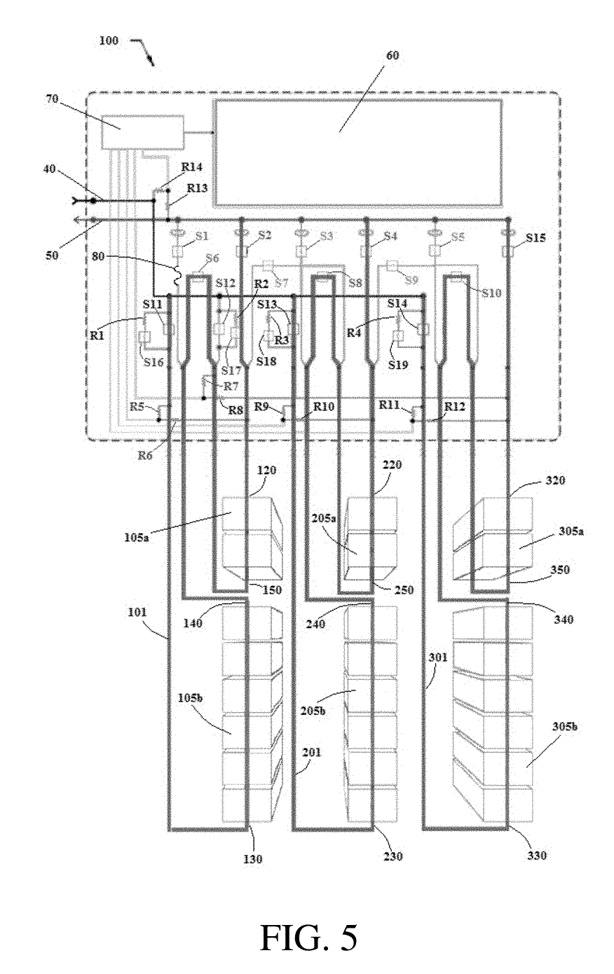

The switches in the exemplary system illustrated in FIGS. 3-5 can, when set to different “on” or “off” positions, allow the system to reconfigure its effective electrical architecture. Switches 51, S2, S3, S4, S5, and S15 are all output switches that, when in an “on” position, each connect the positive terminal of a string to a positive electrical bus. Switches S6, S7, S8, S9, and S10 are all series switches that, when in an “on” position, each connect the negative terminal of one string to the positive terminal of another string. Switches S11, S12, S13, and S14 are all input switches that, when in an “on” position, each connect the negative terminal of a string to a negative electrical bus. This combination of switches allows the illustrated system to be operated in both a “normal” mode and a “boosted” mode, the configurations of which are respectively illustrated in FIG. 4 and FIG. 5.

When operated in the “normal” mode illustrated in FIG. 4, the system configures A energy blocks into C+1 parallel strings, each of which contains F energy blocks in series. This configuration is realized by closing switches S1, S3, S5, S7, S9, S11, S12, S13, S14, and S15, while allowing switches S2, S4, S6, S8, and S10 to remain open (FIG. 4). When operated in the “boosted” mode illustrated in FIG. 5, the system configures A energy blocks into C parallel strings, each of which contains F+D energy blocks in series. This configuration is realized by closing switches S2, S4, S6, S8, S10, S11, S13, S14, and S15, while allowing switches S1, S3, S5, S7, S9, and S12 to remain open. The opening and closing of switches can be performed by a control unit 60 that received an output criteria regarding energy, power, and/or voltage requirements and controls the switches to output power in accordance with the output criteria. Thus, the reconfigurable energy storage system is operable to reconfigure the arrangement of energy storage cells between a series configuration and a parallel configuration, depending on the desired output. This reconfiguration is referred to as string-level dynamic reconfiguration, since it occurs through operation of switches at the string level and can be performed while the system is outputting power.

The system also contains C+1 pre-charge circuits, identified as switches S16, S17, S18, and S19 in FIGS. 3, 4, and 5. These switches close only during switching events, wherein the strings are temporarily electrically connected to the negative bus 40 through a resistor R1, R2, R3, R4 to prevent current surges, arcing, or other artifacts of electrical reconfiguration. It is understood that the pre-charge circuits are not necessary for operation of the reconfigurable energy storage system 100, but, rather, serve as an enhancement of the reconfigurable energy storage system 100 for purposes of safety and device integrity. Furthermore, the system may include one or more fuses 80, such as connected between an output switch S1, S2, S3, S4, S5, S15 and an intra-string positive terminal 140, 240, 340. The fuses 80 are also not necessary for operation of the reconfigurable energy storage system 100, but are nonetheless useful for various applications of the reconfigurable energy storage system 100.

The string-level dynamic reconfiguration enabled by the architecture described herein allows for a range of embodiments and operational modes which are beneficial for large-format energy storage applications. One of these benefits is dynamic string-level isolation, which allows for select energy storage strings to be electrically disengaged from the larger energy storage system while other energy storage strings continue to be cycled. The various switches in the reconfigurable energy storage system can also be utilized to isolate energy storage strings or blocks of energy storage cells while the system is outputting power. This capability is highly practical in large systems containing hundreds or thousands of energy storage cells, as each energy storage cell features a non-negligible failure rate. Systems including large numbers of energy storage cells are therefore very likely to experience periodic cell failures, even if high-quality components are used. Such cell failures can force up to 100% of an energy storage system offline if allowed to propagate through continued cycling, resulting in both system downtime and high maintenance costs. Dynamic string-level fault isolation reduces downtime by allowing for continued use of all unaffected strings and can decrease maintenance costs by preventing faults from spreading throughout the system.

Dynamic string-level isolation offers key advantages over conventional passive isolation systems, which typically rely on fuses that disconnect one or more strings from a system when currents exceed the fuse design rating. The ability to actively isolate strings allows the reconfigurable energy storage system to act on all available system status information, as opposed to just the current through a particular section of the system. For instance, in addition to isolating faults when currents exceed the system design rating, a reconfigurable energy storage system equipped with a compatible monitoring system can also perform isolation when one or more cells begins to exhibit anomalous voltage or temperature characteristics. As shown in FIGS. 3-5, an isolated high voltage measurement unit 70 can be incorporated into the system and configured to provide an output of the voltage from each energy storage string in the system. In such embodiments, the isolated high voltage measurement unit 70 is connected to a circuit with appropriate resistors R5, R6, R7, R8, R9, R10, R11, R12, measuring the electrical potential between the positive terminal of a given energy storage string and the negative terminal of the same energy storage string. The isolated high voltage measurement unit 70 can also be connected to the negative electrical bus 40 and the positive electrical bus 50 through appropriate resistors R13, R14. Such systems can also be used to isolate faults indicated by anomalous current signatures that do not exceed the design rating of the system, such as may occur when an energy storage string is being cycled below its maximum capacity.

The string-level isolation capability can also be used as part of a diagnostic and therapeutic tool within an online energy storage system. Specifically, energy storage strings that are flagged with a potential maintenance issue, are out of balance with other strings in the system, or are simply scheduled for remote performance verification, can be partially cycled by bringing the string online or offline while the remaining strings perform useful charging or discharging cycles. When coupled with suitable monitoring or measurement capabilities, such partial cycling may provide information to diagnose faults within the system, allow for verification of component performance to within design specifications, or even condition cells so that they can be brought into balance with the rest of the system, all without taking the system offline.

The framework described herein can also be implemented in embodiments that allow for improved control of string and system output voltages. Battery cells in particular typically feature cycling profiles that decrease monotonically during cell discharging and increase monotonically during cell charging. The voltage swing between a cell's (and thus a string's) top-of-charge (TOC) voltage and its end-of-charge (EOC) voltage may be as high as 70%. This large voltage range may be incompatible with the end use application of systems deployed in direct-current configurations, and may also be incompatible with the power conditioning system input voltage ranges of systems deployed in alternating-current applications. A system featuring dynamic string-level reconfiguration capabilities may be able to minimize the output voltage range of an energy storage system with no changes to battery chemistry or need for voltage boosters or converters.

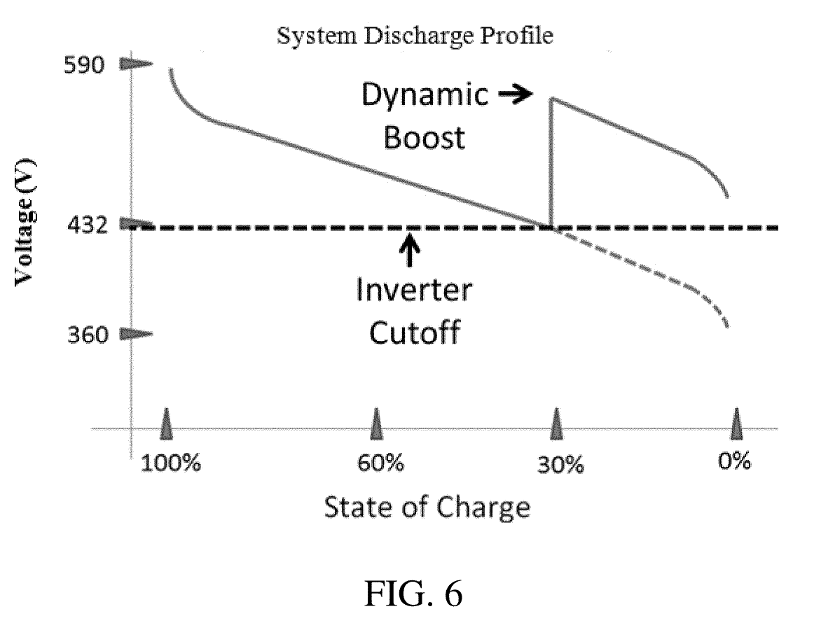

FIG. 6 depicts the discharge profile of the exemplary reconfigurable energy storage system 100 shown in FIG. 3. This system utilizes nickel-cobalt-aluminum lithium-ion cells arranged in strings that feature TOC voltages of 590 volts and EOC voltages of 360 volts. The discharge event shown in FIG. 6 commences when the system is configured in its “normal” mode with four parallel strings of six energy blocks each. As the system discharges, the string (and, hence, the system) voltage drops. When the voltage reaches a predetermined cutoff point of 432 volts, the switches are engaged to reconfigure the system into its “boosted” mode with three parallel strings of eight energy blocks each. The corresponding string (and, hence, the system) voltage rises proportionally. As the system continues to discharge, voltage continues to decrease but remains above that of the “unboosted” system (shown in red).

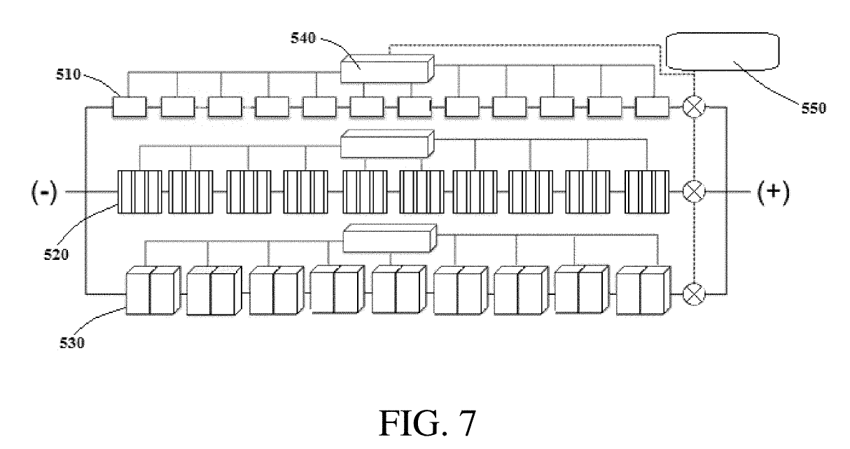

In another embodiment, the reconfigurable energy storage system 100 may be configured with multiple battery chemistries within the same system. FIG. 7 illustrates an embodiment of the reconfigurable energy storage system 100 featuring one string of lithium-ion (Li-ion) battery cells 510, one string of nickel metal hydride (NiMH) battery cells 520, and one string of lead-acid (PbA) battery cells 530. A master controller 550 is connected to the plurality of strings to control the system 100, and a signal acquisition module (SAM) 540 is connected to each string of battery cells to monitor input from the various switches and from the master controller 550.

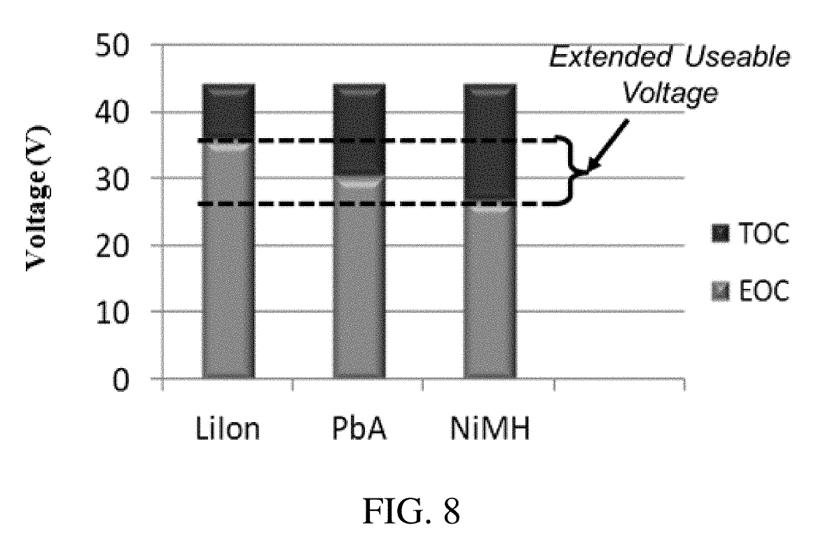

Conventionally, multiple battery chemistries are seldom combined into a single direct-current system due to differences in the charging and discharging profiles of cells with differing chemistries. Even if the strings are designed to ensure a common TOC voltage, it is unlikely that cells featuring different chemistries will share a common EOC voltage. FIG. 8 shows the EOC voltage for each of these strings in the exemplary system shown in FIG. 7. Although each string in this non-limiting example was designed with a TOC voltage of approximately 43 volts, the strings reach EOC at voltages ranging from 27 to 36 volts. In an energy storage system without dynamic string-level reconfiguration, these EOC voltage differences would prohibit the effective use of the strings with lower EOC voltages, as the entire system would need to cease its discharge cycle as soon as the first string reached EOC in order to ensure safe operation. When the same system is equipped with a dynamic string-level reconfiguration capability, however, strings that reach EOC may be selectively isolated while the remaining strings continue to discharge. This allows for each energy storage string to be cycled to its design specifications without being limited by the EOC voltage of other battery chemistries within the system.

In other embodiments, multiple battery chemistries may be incorporated into a system by featuring strings with different flavors of the same chemistry (for example, lithium-ion cells with slightly different chemistries, form factors, or manufacturing tolerances). Effective EOC voltages can also shift as a cell ages, making this configuration equally applicable to strings of old and new cells, such as may be found in mature stationary energy storage systems or energy storage systems featuring second-life battery cells. Systems may also arrange cells of varying chemistries or vintage in segments that allow for reconfiguration of one or more of the cell technologies.

The reconfigurable energy storage system is highly flexible and can be applied to many, if not most, direct-current energy components. Other embodiments of the reconfigurable energy storage system include systems featuring fuel cells, light-emitting diodes, or energy generation or conversion components, such as solar photovoltaic cells or thermoelectric cells. Such technologies benefit from the same isolation and reconfiguration capabilities as systems featuring battery cells.

The foregoing description of the embodiments has been provided for purposes of illustration and description. It is not intended to be exhaustive or to limit the invention. Individual elements or features of a particular embodiment are generally not limited to that particular embodiment but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some examplary embodiments, well-known processes, well-known device structures, and well-known technologies are not described in detail but are well known to those skilled in the art.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and, therefore, specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A reconfigurable energy storage system comprising:
a negative electrical bus;
a positive electrical bus;
a plurality of energy storage strings connected between the negative electrical bus and the positive electrical bus, the plurality of energy storage strings including at least a first energy storage string and a second energy storage string, wherein each energy storage string comprises:
a negative input terminal and a positive output terminal;
at least a first subset of energy storage cells and a second subset of energy storage cells, each subset of energy storage cells including at least two blocks of energy storage cells arranged in an internal series or parallel configuration such that the arrangement includes an intra-string positive terminal and an intra-string negative terminal interposed between the negative input terminal and the positive output terminal;
an input switch connected between the negative electrical bus and the negative input terminal of the energy storage string;
a first output switch connected between the positive electrical bus and the intra-string positive terminal;
a second output switch connected between the positive electrical bus and the positive output terminal of the energy storage string;
a series switch connected between the intra-string positive terminal and the intra-string negative terminal;
a multi-string series switch connected between the positive output terminal of the first energy storage string and the intra-string negative terminal of the second energy storage string;
an initial input switch connected between the negative electrical bus and the intra-string negative terminal of the first energy storage string; and
a control unit in electrical communication with the negative electrical bus, the positive electrical bus, and the plurality of energy storage strings, wherein the control unit is configured to reconfigure (i) at least one parallel arrangement of energy storage cells in the system to a series arrangement of energy storage cells, or (ii) at least one series arrangement of energy storage cells in the system to a parallel arrangement of energy storage cells.

2. The reconfigurable energy storage system of claim 1, wherein the control unit is configured to receive an output criteria defining any combination of energy, power, and voltage requirements.

3. The reconfigurable energy storage system of claim 1, wherein the control unit is configured to control the multi-string series switch and each input switch, output switch, second output switch, and series switch to output power through the negative electrical bus and the positive electrical bus.

4. The reconfigurable energy storage system of claim 1, wherein the control unit is further configured to control engagement of each energy storage string, output voltage, output power, and battery cell cycling characteristics.

5. The reconfigurable energy storage system of claim 1, wherein the energy storage cells are selected from the group consisting of battery cells, fuel cells, capacitors, hybrid battery-capacitor cells, and combinations thereof.

6. The reconfigurable energy storage system of claim 5, wherein the battery cells have differing chemistry, form factor, capacity, and/or performance characteristics.

7. The reconfigurable energy storage system of claim 1, wherein the energy storage cells comprise battery cells having a chemistry selected from the group consisting of: lithium ion, lithium iron phosphate, lithium sulfur, lithium titanate, nano lithium titanate oxide, nickel metal hydride, nickel cadmium, nickel hydrogen, nickel-iron, sodium sulfur, vanadium redox, rechargeable alkaline, or aqueous hybrid ion.

8. The reconfigurable energy storage system of claim 1, wherein the plurality of energy storage strings further includes a third energy storage string and the reconfigurable energy storage system further includes a second multi-string series switch connected between the positive output terminal of the second energy storage string and the intra-string negative terminal of the third energy storage string.

9. The reconfigurable energy storage system of claim 8, wherein the first energy storage string and the second energy storage string comprise battery cells of the same chemistry.

10. The reconfigurable energy storage string of claim 8, wherein the first energy storage string, the second energy storage string, and the third energy storage string comprise battery cells of the same chemistry.

11. The reconfigurable energy storage string of claim 8, wherein the first energy storage string includes battery cells of a first chemistry, and the second energy storage string includes battery cells of a second chemistry.

12. The reconfigurable energy storage system of claim 8, wherein the first energy storage string comprises Li-ion battery cells, the second energy storage string comprises lead-acid battery cells, and the third energy storage string comprises nickel metal hydride battery cells.

13. The reconfigurable energy storage system of claim 1, wherein each energy storage string comprises a first subset of two energy storage cells and a second subset of six energy storage cells.

14. The reconfigurable energy storage system of claim 13, wherein the system has three energy storage strings.

15. The reconfigurable energy storage string of claim 1, wherein the first energy storage string includes battery cells of at least two different chemistries.

16. The reconfigurable energy storage system of claim 1, further comprising a pre-charge circuit having a switch and a resistor, the pre-charge circuit being connected between the negative electrical bus and the negative input terminal of at least one energy storage string, wherein the pre-charge circuit is configured to close during a switching event so as to temporarily electrically connect the negative electrical bus to the resistor.

17. The reconfigurable energy storage system of claim 16, wherein each energy storage string in the system includes a pre-charge circuit.

18. The reconfigurable energy storage system of claim 1, further comprising a fuse connected between the output switch and the intra-string positive terminal of one or more of the energy storage strings.

19. The reconfigurable energy storage system of claim 1, further comprising an isolated high voltage measurement unit configured to provide a voltage reading from at least one energy storage string in the system, the isolated high voltage measurement unit being connected to a circuit between the positive output terminal and the negative output terminal of the battery string.

20. The reconfigurable energy storage system of claim 19, wherein the isolated high voltage measurement unit is configured to provide a voltage reading from every energy storage string in the system.

21. The reconfigurable energy storage system of claim 1, wherein at least one energy storage cell comprises an energy generation component.

22. A method of reconfiguring an energy storage system, the method comprising:
providing an energy storage system with a plurality of energy storage strings connected to a positive electrical bus and a negative electrical bus through a circuit containing a plurality of switches, each energy storage string containing a plurality of interconnected energy storage cells, wherein the energy storage system includes a control unit in electrical communication with the plurality of energy storage strings; and
controlling one or more of the switches through the control unit so as to change the configuration of two or more of the energy storage cells in the energy storage system either (i) from a parallel configuration to a series configuration, or (ii) from a series configuration to a parallel configuration, to reconfigure the battery system.

23. The method of claim 22, wherein the energy storage system exhibits a boosted power output for a period of time after the reconfiguration.

24. A method of cycling energy storage strings, the method comprising:
providing an energy storage system with a plurality of energy storage strings connected to a positive electrical bus and a negative electrical bus through a circuit containing a plurality of switches, each energy storage string containing a plurality of interconnected energy storage cells, wherein the energy storage system includes a control unit in electrical communication with the plurality of energy storage strings;
discharging the energy storage strings to produce an output; and
reconfiguring the energy storage system by operation of the plurality of switches so as to selectively isolate one or more of the energy storage strings while allowing the remaining energy storage strings to continue discharging.
